(19) United States
(12) Patent Application Publication
(10) Pub. No.: US 2005/0257391 A1
(43) Pub. Date: Nov. 24, 2005

(54) Apparatus for verifying dimensional relationships

(75) Inventor: Stuart W. Driscoll, Dublin, OH (US)

Correspondence Address: WOOD, HERRON & EVANS, LLP, 2700 CAREW TOWER, 441 VINE STREET, CINCINNATI, OH, 45202, US

(73) Assignee: SOAR Ventures, L.L.C.

(21) Appl. No.: 10/851,876

(22) Filed: May 21, 2004

(51) Int. Cl. B43L 7/00

(52) U.S. Cl. 33/566

(57) ABSTRACT

A device for verifying dimensional relationships of buildings or facilities to ensure compliance with guidelines or requirements, such as the Americans with Disabilities Act. The device comprises a planar member having various geometric features and indicia arranged to facilitate quickly and easily verifying whether a particular dimensional relationship is met. Advantageously, the device is capable of verifying compliance with two related dimensional relationships simultaneously. The indicia are configured to facilitate photographing the device during a measurement so that a record may be maintained for future reference.

### FIELD OF THE INVENTION

The present invention relates to the measurement of dimensional relationships between associated objects, and more specifically to the measurement of dimensional relationships to verify compliance with guidelines or requirements.

### BACKGROUND OF THE INVENTION

In recent years, conscious efforts have been made to design and construct various public and private buildings and facilities to accommodate handicapped or disabled persons. To facilitate and encourage these efforts, various standards and legislative acts have been developed to establish guidelines for public and private buildings and facilities to facilitate the use of such buildings and facilities by such persons. For example, the Americans with Disabilities Act (ADA) of 1990 establishes guidelines for promoting accessibility to buildings and facilities by persons with disabilities. These guidelines establish the minimum requirements for the spacing and arrangement of entranceways, walkways, drinking fountains, bathroom facilities, fixed or built-in seating and tables, hand rails and grab bars, and stairs, ramps or elevators, to name a few.

Presently, no device is available which allows individuals to readily measure multiple and simultaneous spatial relationships between various elements of the buildings or facilities to determine whether they are in compliance with such guidelines. Moreover, no device is presently available which facilitates prescriptive documentation of such compliance in an easily photographable format for future reference. The ability to readily ascertain compliance and document compliance for future reference is particularly important for businesses which have buildings or facilities in multiple locations, such as department stores, restaurants, and other businesses providing goods and services to the public.

There is thus a need for a device that quickly and easily facilitates multiple, repetitive and simultaneous measurement to verify whether a given facility or building feature meets established guidelines such as the ADA or other similar guidelines.

### SUMMARY OF THE INVENTION

The present invention provides a device or template that can be used to readily determine whether various features of buildings and facilities comply with predetermined guidelines or requirements, such as those set forth in the Americans with Disabilities Act. In one embodiment, the device comprises a planar member having at least one side surface, and geometric features formed on the planar member for verifying dimensional relationships. The device further includes various indicia disposed on the side surface to indicate the location of one or more reference dimensions relative to the geometric feature. Accordingly, the device can be used to quickly and easily determine whether a feature of a building or facility is in compliance by visual inspection.

In one embodiment, the geometric features comprise multiple pairs of oppositely disposed side edges that are spaced apart distances corresponding to the dimensional requirements or guidelines desired to be verified. In another embodiment, the geometric features include circular arcs that may be used to verify prescribed diameters of grab bars or hand rails, and related clearances from adjacent surfaces and objects. In yet another embodiment, the geometric features include profile forms for determining compliance of a stair tread nosing profile, a door threshold, and the allowable vertical offset in a path of travel.

In yet another embodiment, the device is collapsible from an extended configuration useful for verifying compliance of dimensional relationships, to a compact configuration which is convenient for storage and transportation of the device. This embodiment may further include locking mechanisms that facilitate maintaining the device in the extended configuration, and which may be manipulated to allow the device to be collapsed to the compact configuration.

The features and objectives of the present invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a plan view of one embodiment of an exemplary device for verifying dimensional relationships according to the present invention;

FIGS. 2A-2C are plan views depicting other embodiments of devices similar to that shown in FIG. 1, according to the present invention;

FIG. 3A is a perspective view of another embodiment of a device for verifying dimensional relationships, according to the present invention;

FIGS. 3B and 3C depict the device of FIG. 3A being folded for compact storage; and

FIGS. 4A-4B are perspective detail views depicting a locking feature for use with the device of FIG. 3A.

### DETAILED DESCRIPTION

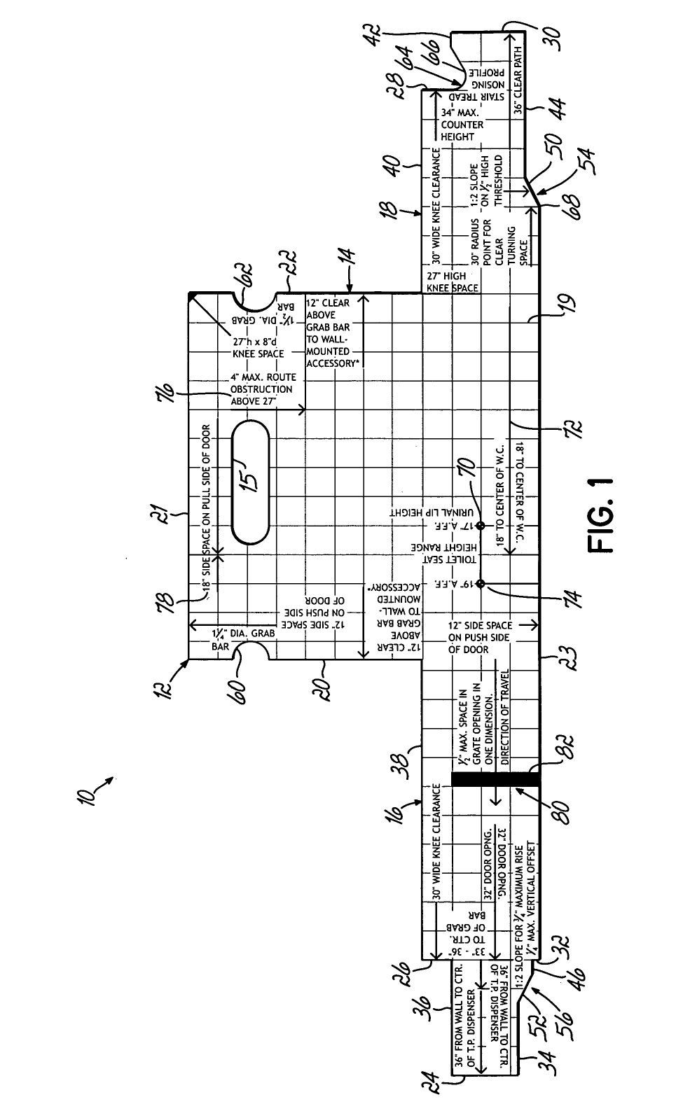

Referring now to FIG. 1, there is shown an exemplary device 10, according to the present invention, for verifying dimensional relationships between associated objects, for example, to verify compliance of the dimensional relationships with guidelines such as the Americans with Disabilities Act of 1990 (ADA). In the embodiment shown, the device 10 includes a planar member 12 having a generally rectangular-shaped central body portion 14, and two oppositely disposed, elongate arms 16, 18 extending outwardly therefrom. The planar member 12 includes various geometric features formed thereon and arranged to facilitate verification of the desired dimensional relationships. An aperture 15 may be formed through the planar member, for use as a handle to facilitate carrying or handling the device 10. The planar member 12 further includes various indicia disposed on a side face of the planar member 12 and positioned to facilitate verifying the dimensional relationships between the geometric features, or to indicate the location of one or more reference dimensions relative to a geometric feature.

In the embodiment shown, the indicia include text that identifies the geometric features associated with each of the desired dimensional relationships, as will be described more fully below. The indicia further include a grid 19 of 1-inch×1-inch squares superposed upon the side surface of the planar member to facilitate ascertaining the dimensional relationships. The indicia may be printed, etched, stamped or formed on the planar member by other methods suitable to provide visible indicia.

With continued reference to FIG. 1, the geometric features include various straight side edges formed around the periphery of the planar member 12. Advantageously, the side edges establish reference locations which, used together with other geometric features or indicia on the planar member, permit persons to readily ascertain whether a desired dimensional relationship is met by the building or facility structure that is being checked.

In the embodiment shown in FIG. 1, the central body portion 14 has first and second oppositely disposed, vertically-extending side edges 20, 22 spaced approximately 12-⅝ inches apart and first and second oppositely disposed laterally-extending side edges 21, 23 spaced approximately 12.0 inches apart. The second laterally-extending side edge 23 continues along the elongate arms 16, 18. The device further includes third, fourth, fifth, sixth and seventh vertically-extending side edges 24, 26, 28, 30, 32, and third, fourth, fifth, sixth, seventh, eighth and ninth laterally-extending side edges 34, 36, 38, 40, 42, 44, 46 disposed on the first and second arm members 16, 18 of the planar member 12. The third and fourth vertically-extending side edges 24, 26 are disposed on an opposite side of the planar member 12 from the fifth and sixth vertically-extending side edges 28, 30. The third and sixth vertically-extending side edges 24, 30 are spaced apart approximately 36 inches. The third and fifth vertically-extending side edges 24, 28 are spaced apart approximately 34 inches. The fourth and sixth vertically-extending side edges 26, 30 are spaced apart approximately 32 inches, and the fourth and fifth vertically-extending side edges 26, 28 are spaced apart approximately 30 inches. Accordingly, the third through sixth vertically-extending side edges 24, 26, 28, 30 may be used to verify compliance with various dimensional guidelines set out in the ADA, such as a 30-inch-wide knee clearance, a 32-inch-wide door opening, a 34-inch maximum counter height, a 36-inch length from a wall to the center of a toilet paper dispenser, and a 36-inch-wide clear path dimension.

The second, third, eighth and ninth laterally-extending side edges 23, 34, 44, 46 are disposed on opposite sides of the planar member 12 from the first, fourth, fifth, sixth and seventh laterally-extending side edges 21, 36, 38, 40, 42 of the planar member 12. The first and second laterally-extending side edges 21, 23 are spaced apart approximately 12.0 inches, as noted above. The first and sixth laterally-extending side edges 21, 40 are spaced approximately 8 inches apart. The second and third laterally-extending side edges 23, 34 are spaced apart approximately 0.75 inch. The second and ninth laterally-extending side edges 23, 46 are spaced apart approximately 0.25 inch. The second and eighth laterally-extending side edges 23, 44 are spaced apart approximately 0.5 inch.

The second and eighth laterally-extending side edges 23, 44 have confronting ends that are spaced approximately 1.0 inch apart along a direction parallel to the side edges 23, 44, and are interconnected by a skew edge 50 extending therebetween to form a 1:2 slope. Likewise, the third and ninth laterally-extending side edges 34, 46 have confronting ends spaced apart approximately 1.5 inch along a direction parallel to the side edges 34, 46, and which are interconnected by a skew edge 52 extending therebetween to form a 1:2 slope.

Advantageously, the laterally-extending side edges may be used alone, or in conjunction with other geometric features of the device to verify various ADA dimensional guidelines. For example, the first and sixth laterally-extending side edges 21, 40 may be used to verify an 8-inch minimum knee space depth. Advantageously, the first and sixth laterally-extending side edges 21, 40 may be used in conjunction with the second and third vertically-extending side edges 22, 24 to simultaneously verify a knee space having dimensions which are 27 inches high and 8 inches deep.

The second and eighth laterally-extending side edges 23, 44 and the skew edge 50 extending therebetween form a geometric feature 54 that may be used to verify a 1:2 slope on a 1/2-inch-high threshold. Likewise, the second and third laterally-extending side edges 23, 34 together with the skew edge 52 extending between the third and ninth laterally-extending side edges 34, 46 form a geometric feature 56 that may be used to verify compliance with a 3/4-inch maximum rise having a 1:2 slope. The second and ninth laterally-extending side edges 23, 46 may be used to verify compliance of a ¼-inch maximum vertical offset, such as may exist in a facility between a first floor surface and a floor covering, such as tile or wooden planks.

The device 10 may further include other geometric features such as circular arcs and stair tread nosing profile features. In the exemplary embodiment shown, a first circular arc 60 having a radius of approximately 0.625 inch is formed along the first vertically-extending side edge 20 and is positioned such that its center is spaced approximately 12.625 inches from the second vertically-extending side edge 22 and approximately 2.125 inches from the first laterally-extending side edge 21. A second circular arc 62 having a radius of approximately 0.75 inch is formed along the second vertically-extending side edge 22 and has a center spaced approximately 12.75 inches from the first vertically-extending side edge 20 and approximately 2.25 inches from the first laterally-extending side edge 21. Advantageously, the first and second circular arcs 60, 62 may be used to verify the clearance space above 1-¼ diameter and 1-½ diameter grab bars, respectively, and to prescribe a 1-½ inch clearance between the grab bars and an adjacent wall. While the clearance dimensions above the grab bars are not required by the ADA, they are examples of other dimensional relationships that may be verified by the device 10, as may be desired by individual user requirements.

A stair tread nosing profile 64 is provided on the second arm 18 of the planar member 12, between the sixth and seventh laterally-extending side edges 40, 42 and the fifth and sixth vertically-extending side edges 28, 30. The profile 64 includes an arc 66 formed between the seventh laterally-extending side edge 42 and the fifth vertically-extending side edge 28, whereby the planar member 12 may be positioned adjacent a stair tread with the fifth vertically-extending side edge 28 abutting the tread and the seventh laterally-extending side edge 42 abutting the riser beneath the tread. The arc 66 is formed such that in a compliant stair, the seventh laterally-extending side edge 42 will abut the riser prior to the arc 66 contacting the nosing of the tread.

Advantageously, the corner 68 formed between the second laterally-extending side edge 23 and the skew edge 50 between the second and eighth laterally-extending side edges 23, 44 forms a pivot point that is spaced approximately 30 inches from the third vertically-extending side edge 24, whereby the device 10 may be positioned on a floor and pivoted about the corner so that the third vertically-extending side edge 24 may be swung in an arc about the pivot point, for example, to verify a 30-inch radius (60-inch diameter) clear turning space according to the ADA.

With continued reference to FIG. 1, the indicia are disposed on a side face of the planar member, as described above, and are sized and spaced such that the device may be photographed during the process of verifying one or more dimensional relationships between two objects and such that the indicia will be legible in the photograph without the need for magnification. In one embodiment, textural letters of the indicia are at least approximately 0.25-inch high.

As shown in FIG. 1, the indicia include text and symbols to indicate reference dimensions 70, 72, 74 located approximately 17 inches, 18 inches, and 19 inches from the sixth vertically-extending side edge. Advantageously, these reference dimensions 70, 72, 74 facilitate verifying compliance of a 17-inch urinal lip height above a finished floor, an 18-inch dimension from a wall to the center of a water closet, and a 17 to 19-inch toilet seat height range above a finished floor.

The indicia further include text and symbols to indicate a reference dimension 76 spaced 4 inches from the first laterally-extending side edge 21, for example, to verify compliance with a 4-inch maximum route obstruction above the 27-inch-high cane-detectable space established by the second and third vertical-extending side edges 22, 24. The indicia may further include text and symbols to indicate a reference dimension 78 located approximately 18 inches from the sixth vertically-extending side edge 30, for example, to verify an 18-inch side space on the pull-side of a door, as required by the ADA. The 12-inch spacing between the first and second laterally-extending side edges 21, 23 may similarly be used to verify compliance with a 12-inch side space on the push-side of a door, as required by the ADA.

The indicia may further include text and symbols to indicate a reference dimension 80 corresponding to a ½-inch maximum space which may be present in a grate opening along the direction of travel of a wheelchair. In the exemplary embodiment shown, these indicia comprise one or more solid rectangular blocks 82 disposed adjacent the second laterally-extending side edge 23 of the planar member 12. To verify compliance, the planar member 12 is placed over the grate with the second laterally-extending side edge 23 contacting the grate and the first and second arms 16, 18 extending in the direction of travel. The solid blocks 82 are then aligned with the spacing formed in the grate to provide a visual indication of whether the spacings comply with the maximum permissible opening size.

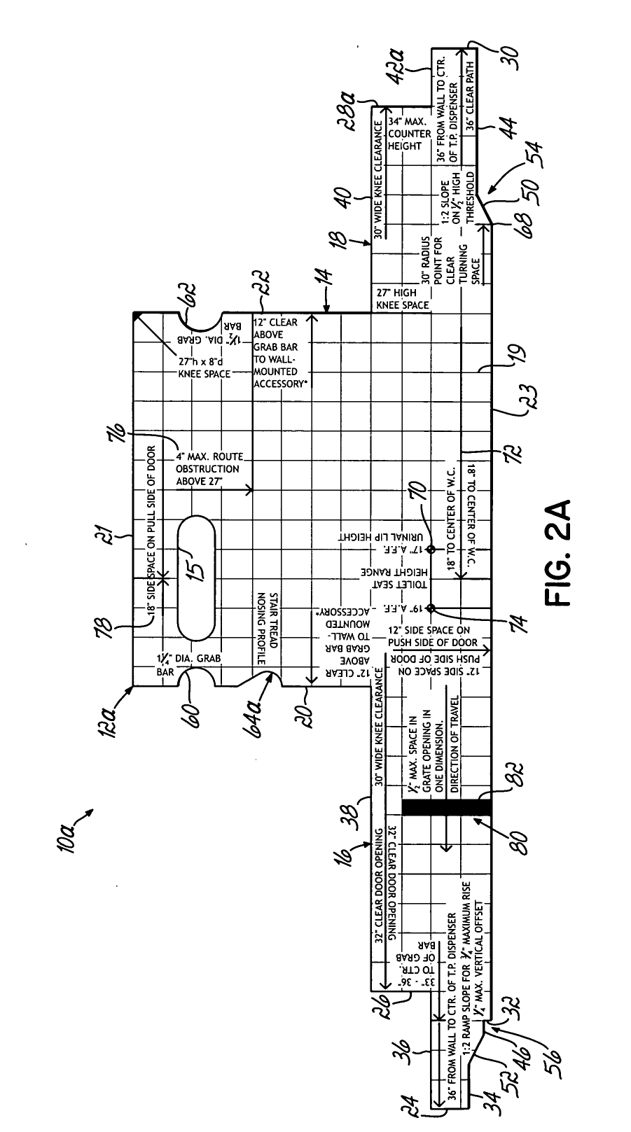

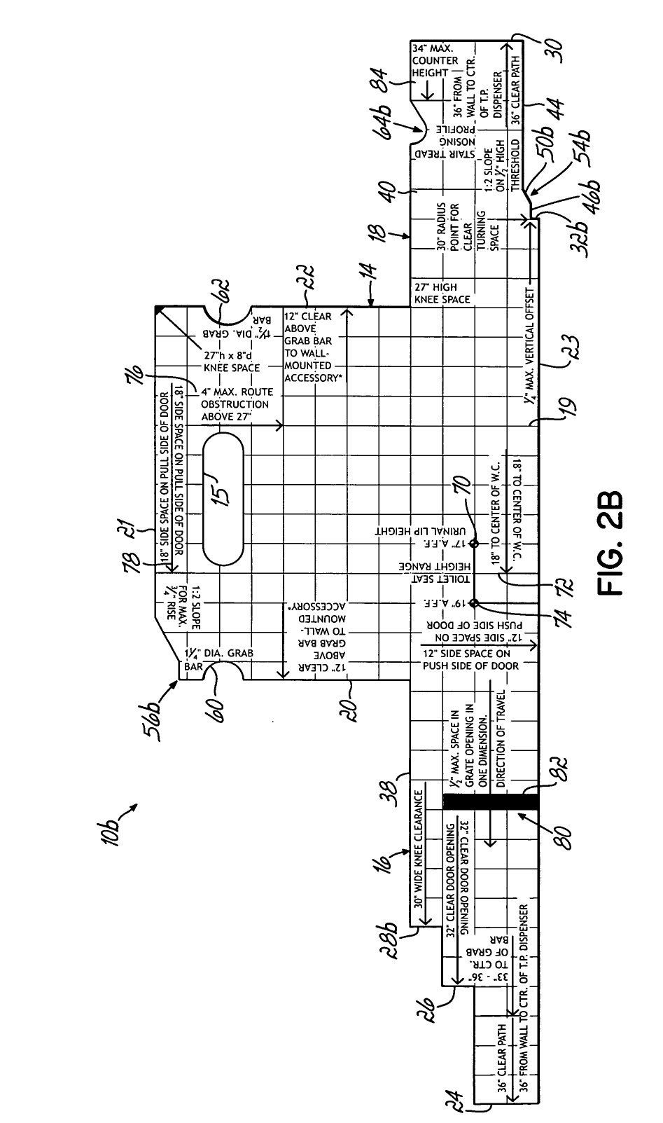

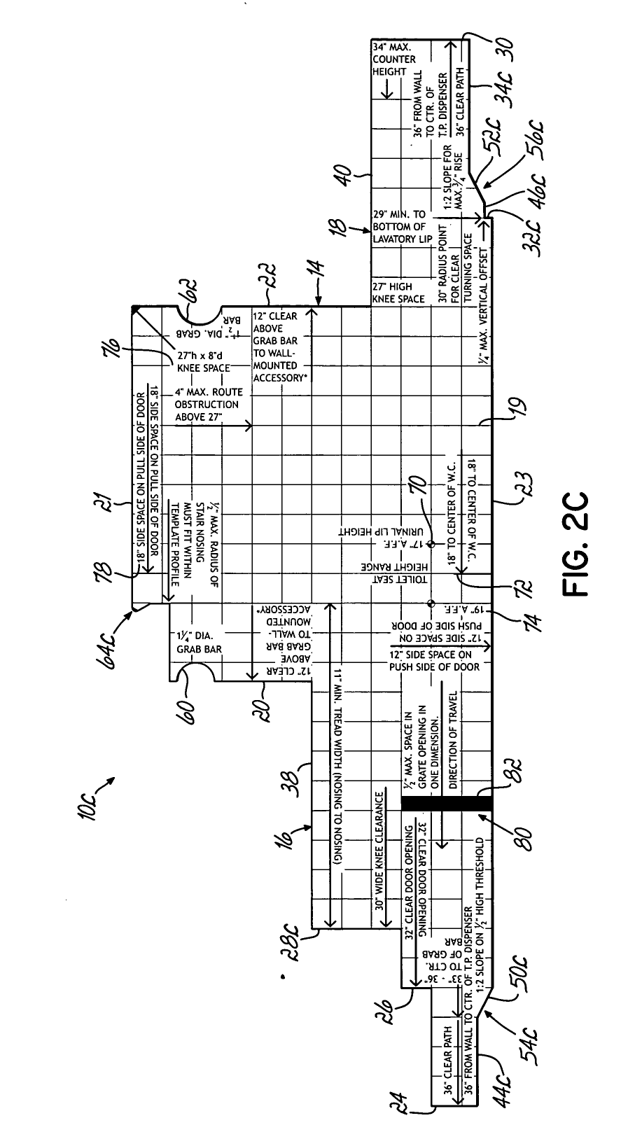

Referring now to FIGS. 2A-2C, there are shown various other embodiments of devices for verifying dimensional relationships between associated objects, similar to the device shown in FIG. 1. In FIGS. 2A-2C, like features have been similarly numbered and suffix letters have been added to reference numerals that are varied from the features depicted in FIG. 1. For example, the device 10a shown in FIG. 2A is similar to the device 10 of FIG. 1, with the exception that the stair tread nosing profile 64a is formed into the first vertically-extending side edge 20. Accordingly, the fifth vertically-extending side edge 28a and the seventh laterally-extending side edge 42a have been modified from the embodiment depicted in FIG. 1. The remaining features correspond to the features of the device 10 depicted in FIG. 1 and discussed above.

FIG. 2B shows another embodiment of a device 10b according to the present invention, similar to the device 10 of FIG. 1, but wherein various geometric features are formed on different portions of the planar member. For example, the geometric features 56b for verifying a ¾-inch high maximum rise have been formed on the first laterally-extending side edge 21, and the geometric features 32b, 46b for verifying a ¼-inch maximum vertical offset are formed on the second laterally-extending side edge 23, but are positioned adjacent the geometric features 50b, 54b for verifying the 1:2 slope on a ½-inch high threshold. The device 10b further includes a stair tread nosing profile 64b formed further inboard from the sixth vertically-extending side edge 30. The fifth vertically-extending side edge 28b is now located on the first arm 16. In addition, the features for verifying the 34-inch maximum counter height dimension have been modified to include indicia in the form of the text and symbols that indicate a reference dimension 84 spaced approximately 34 inches from the third vertically-extending side edge 24.

Referring now to FIG. 2C, there is shown yet another exemplary embodiment of a device 10c according to the present invention, similar to the device 10b of FIG. 2B, with the exception that a stair tread nosing profile 64c is formed between the first laterally-extending side edge 21 and the first vertically-extending side edge 20. Moreover, the stair tread nosing profile 64c can be used with the fifth vertically-extending side edge 28c (located on first arm 16) to verify a minimum stair tread depth. In addition to repositioning the stair tread nosing profile 64c, the geometric features 44c, 50c, 54c for verifying a 1:2 slope on a ½-inch high threshold are formed into the second laterally-extending side edge 23, adjacent the third vertically-extending side edge 24. The geometric features 34c, 52c, 56c for verifying the 1:2 slope on a maximum ¾-inch high rise, and the geometric features 32c, 46c for verifying a ¼-inch maximum vertical offset are formed into the second laterally-extending side edge 23, adjacent the sixth vertically-extending side edge 30. The third and eighth laterally-extending side edges 34c, 44c are located on the second and first arms 18, 16, respectively, to correspond to the respective slope verifying features 54c, 56c. Otherwise, the remaining geometric features and indicia are similar to those described above.

As demonstrated by the various embodiments shown in FIGS. 1 and 2A-2C, it will be recognized that the geometric features and indicia may be selectively positioned at various locations on the planar member 12. The device is therefore not limited to the specific embodiments disclosed herein. Moreover, it will be recognized that while the various geometric features have been shown and described as vertically-extending or laterally-extending straight side edges and arcs, various other forms of geometric features may be used to establish positive locations to facilitate verifying dimensional relationships, as discussed above.

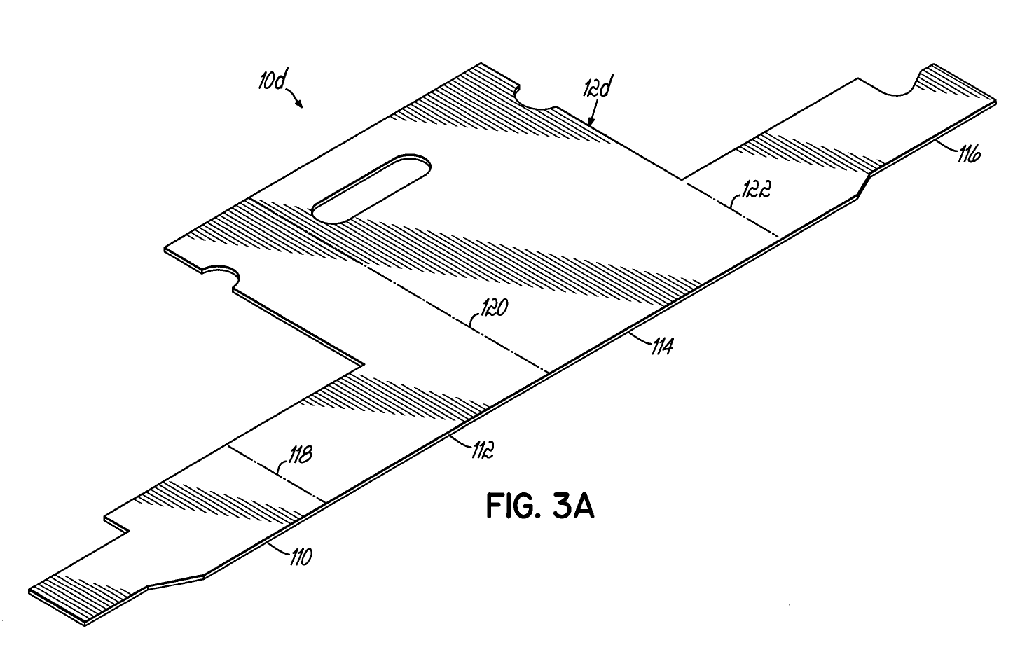

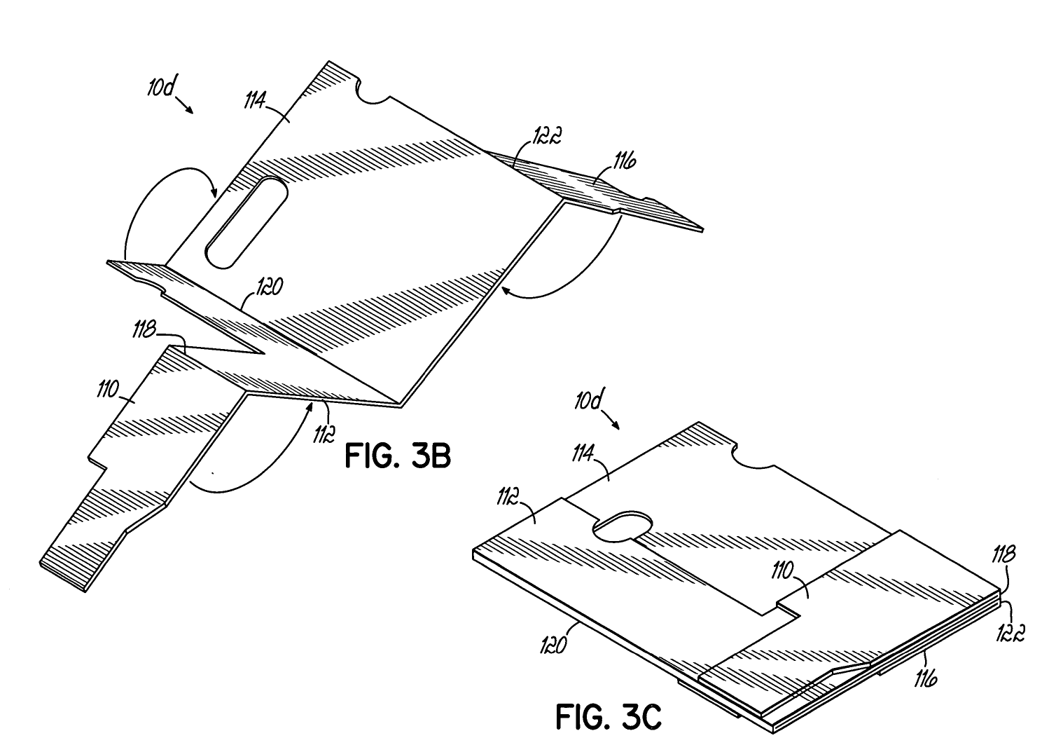

Referring now to FIGS. 3A-3C, there is shown yet another exemplary embodiment 10d of the device of FIG. 1 wherein the planar member 12d comprises several planar sections hingedly coupled together to facilitate collapsing the planar member 12d from a first, extended configuration, wherein the device may be used to verify dimensional relationships, as discussed above, to a second, compact configuration for convenient transportation and storage of the device. In the exemplary embodiment shown, the planar member 12d comprises first, second, third, and fourth planar sections 110, 112, 114, 116 hingedly coupled along first, second and third hinge lines 118, 120, 122. Advantageously, the first and second sections 110, 112 may be folded along the first hinge line 118 and the third and fourth sections 114, 116 folded along the third hinge line 122, as depicted in FIG. 3B, whereafter the second and third sections 112, 114 may be folded along the second hinge line 120 to collapse the planar member 12d to the compact configuration depicted in FIG. 3C. The hinged portions of the device 10d may comprise living hinges formed directly into the material of the planar member 12d, separate hinge devices embedded into or otherwise secured to the adjacent sections of the planar member, or any other hinge arrangement configured to facilitate folding the planar member 12d.

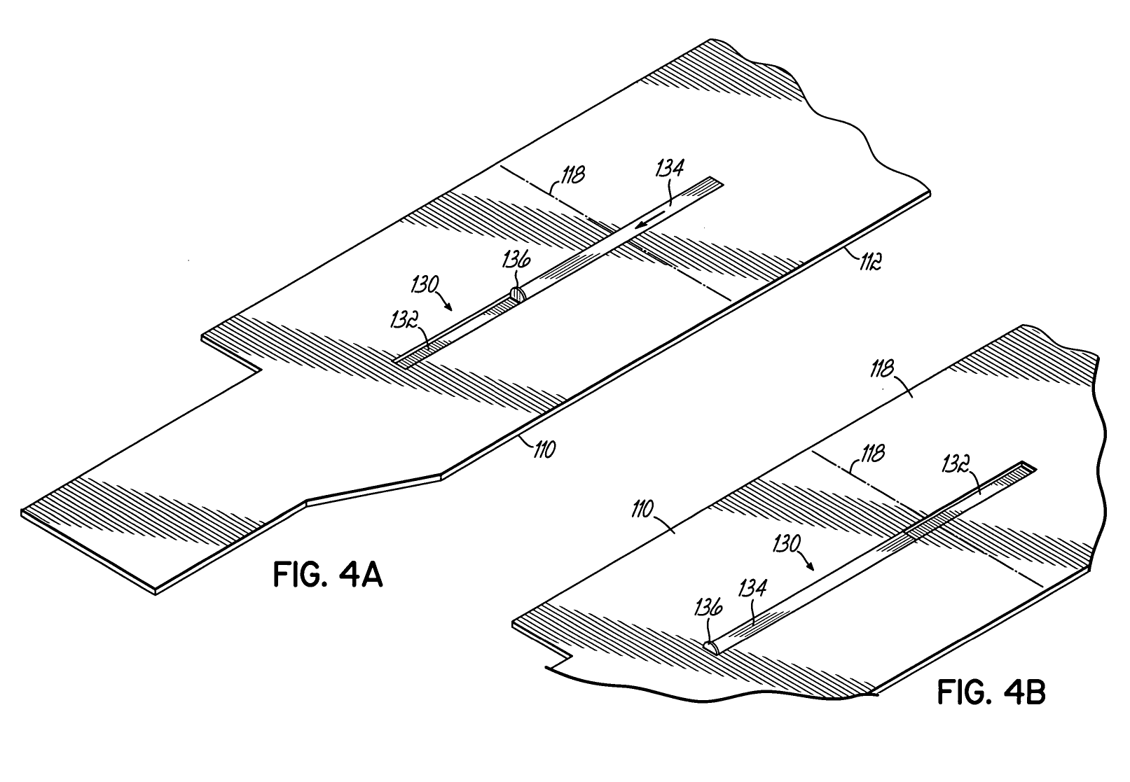

Referring now to FIGS. 4A and 4B, there is shown a locking mechanism 130 which can be used with the device 10d of FIGS. 3A-3C to help maintain the planar member 12d in the extended configuration. The locking mechanism 130 is slidably coupled to the planar member 12d between adjacent sections of the planar member. In the embodiment shown, the locking mechanism 130 includes a slot 132 formed into a side face of the planar member 12d and a relatively rigid elongate member 134 slidably disposed within the slot 132. The elongate member 134 is movable within the slot 132 from a first, locked position wherein the elongate member extends across the hinge line 118 between the adjacent sections 110, 112 of the planar member 12d, as depicted in FIG. 4A. The elongate member 134 is slidable within the slot 132 to a second, unlocked position wherein the elongate member 134 is completely disposed on one side of the hinge line 118. An upturned finger tab 136 may be provided on the elongate member 134 to facilitate sliding the elongate member 134 in the slot 132. When the elongate member 134 is in the first, locked position, the elongate member 134 prevents the adjacent sections 110, 112 from being folded along the hinge line 118. When the elongate member 134 is thereafter moved to the second, unlocked position, the first and second sections 110, 112 of the planar member 12d are free to be folded along the hinge line 118. Similar locking mechanisms may be provided between the other folding sections 112, 114, 116 of the device 10d.

While the present invention has been illustrated by the description of the various embodiments thereof, and while the embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

1. A device for verifying dimensional relationships between associated objects, comprising:
a planar member having at least one side surface;
geometric features formed on said planar member, at least some of said geometric features arranged to verify dimensional relationships in at least two different directions;
at least one pair of said geometric features operative to verify two different dimensional relationships simultaneously: and
indicia disposed on said side surface of said planar member and indicating the location of one or more reference dimensions relative to said geometric features.

2. (canceled)

3. The device of claim 1, wherein said geometric features include at least two of:
a pair of oppositely disposed, parallel side edges spaced approximately 27 inches apart;
a pair of oppositely disposed, parallel side edges spaced approximately 30 inches apart;
a pair of oppositely disposed, parallel side edges spaced approximately 32 inches apart;
a pair of oppositely disposed, parallel side edges spaced approximately 35 inches apart;
a pair of oppositely disposed, parallel side edges spaced approximately 36 inches apart;
a pair of parallel side edges spaced approximately 0.5 inch apart and having respective ends spaced approximately 1.0 inch apart along a direction parallel to said side edges, said respective ends interconnected by a skew edge extending therebetween;
a pair of parallel side edges spaced approximately 0.75 inch apart and having respective ends spaced approximately 1.5 inch apart along a direction parallel to said side edges, said respective ends interconnected by a skew edge extending therebetween; and
a pair of parallel side edges spaced approximately 0.25 inch apart.

4. The device of claim 3, wherein said geometric features further Include at least one of:
a pair of oppositely disposed, parallel side edges spaced approximately 12 inches apart: and
a pair of oppositely disposed, parallel side edges spaced approximately 12.625 inches apart.

5. The device of claim 3, wherein said geometric features further include at least one of:
a first circular arc having a radius of approximately 0.625 inch; and
a second circular arc having a radius of approximately 0.75 inch.

6. The device of claim 5, wherein:
said first circular arc has a center spaced approximately 12.625 inches from a first straight edge, and approximately 2.125 inches from a second straight edge perpendicular to the first straight edge; and
said circular arc has a center spaced approximately 12.75 inches from a first straight edge, and approximately 2.25 inches from a second straight edge perpendicular to the first straight edge.

7. The device of claim 1, wherein said geometric features include a nosing profile for a stair tread, said nosing profile indicating a maximum geometry of a stair tread nosing profile.

8. The device of claim 1, wherein said indicia are sized and spaced such that the device may be photographed while verifying a dimensional relationship between two objects, with said indicia legible in the photograph without magnification.

9. The device of claim 3, wherein said indicia includes at least one of:
a reference dimension spaced approximately 4.0 inches from one of said side edges;
a reference dimension spaced approximately 17 inches from one of said side edges;
a reference dimension spaced approximately 18 inches from one of said side edges;
a reference dimension spaced approximately 19 inches from one of said side edges;
a reference dimension spaced approximately 30 inches from one of said side edges;
a reference dimension spaced approximately 33 inches from one of said side edges; and
a reference dimension indicating a spacing of approximately 0.5 inch.

10. The device of claim 1, wherein said planar member is collapsible from a first extended position to a second compact position.

11. The device of claim 10, wherein said planar member comprises at least two sections hingedly coupled together for folding to said second compact position.

12. The device of claim 11, wherein said planar member comprises a living hinge coupling said at least two sections.

13. The device of claim 11, further comprising a locking member slidably coupled to said planar member for movement between said at least two sections, said locking member movable from a first position wherein said sections are locked in said extended position, and a second position wherein said sections are movable to said second compact position.

14. A template for verifying compliance with dimensional requirements of the Americans with Disabilities Act, comprising:
a planar member having multiple pairs of opposing edges, each pair of opposing edges disposed at distances from one another that correspond to a specific minimum dimension set forth in the Americans with Disabilities Act.

15. The template of claim 14, wherein at least one pair of opposing edges is operative to verify two different dimensional relationships simultaneously.
